(19) United States
(12) Patent Application Publication
(10) Pub. No.: US 2024/0273643 A1
(43) Pub. Date: Aug. 15, 2024

(54) METHOD AND SYSTEM FOR PROVIDING TECHNICAL SERVICE TO AN AGRICULTURAL WORKING MACHINE

(71) Applicant: CLAAS Selbstfahrende Erntemaschinen GmbH, Harsewinkel (DE)

(72) Inventors: Scott Wellensiek, Harsewinkel (DE); Christoph Tetzlaff, Omaha, NE (US); G. Eric Raby, Bucyrus, KS (US); Timothy Conrad, Omaha, NE (US); Brian Abrahams, Blair, NE (US); Jeffrey Tilden, Columbus, IN (US); Daryl Theis, Gretna, NE (US); Mark Turnis, Treynor, IA (US); Patricio Frangella, Columbus, IN (US)

(73) Assignee: CLAAS Selbstfahrende Erntemaschinen GmbH, Harsewinkel (DE)

(21) Appl. No.: 18/374,847

(22) Filed: Sep. 29, 2023

(30) Foreign Application Priority Data
Feb. 9, 2023 (DE) 10 2023 103 208.9

(51) Int. Cl. G06Q 50/02; G06Q 10/0631; G06Q 10/0834; G06Q 10/0835; G06Q 10/0875; G06Q 10/20

(52) U.S. Cl. CPC G06Q 50/02; G06Q 10/06312; G06Q 10/0834; G06Q 10/08355; G06Q 10/0875; G06Q 10/20

(57) ABSTRACT

A method for providing technical service to an agricultural working machine is provided. A digital service module of a server coordinating the technical service receives a request for service, the request for service including at least one part and at least one service needed to fix a problem with the agricultural working machine. The server includes a database, which stores information about locations of parts (which may be in service vehicles, locations assigned to service providers, or at a central storage), service providers, and part runners. The digital service module determines: (i) possible service events at which the service provider can fix the problem of the agricultural working machine; (ii) possible routes for the part runners to deliver the at least one part from central storage; (iii) the part runner, from a plurality of available part runners, to deliver the part; (iv) the service vehicle, from a plurality of available service vehicles, to provide the service; and (v) the at least one part, from a plurality of parts usable for the service.

### CROSS REFERENCE TO RELATED APPLICATION

This application claims priority under 35 U.S.C. § 119 to German Patent Application No. DE 10 2023 103 208.9 filed Feb. 9, 2023, the entire disclosure of which is hereby incorporated by reference herein.

### TECHNICAL FIELD

The present invention relates to a method for providing technical service to an agricultural working machine.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Agricultural working machines regularly need technical service, including repairs, changes of damaged and worn parts and upgrades. Typically, this technical service is often done at dedicated servicing locations. A customer owning an agricultural working machine in need of such service then must transport the agricultural working machine to the servicing location. A service provider at the servicing location thereafter locates a problem, orders parts to fix the problem, and provides the needed services to fix the problem. Afterwards, the customer may pick up the agricultural working machine from the servicing location.

Problems with agricultural working machines often occur during use and lead to downtime of the agricultural working machine. Downtime for agricultural working machines may have significant negative impacts on farmers and agricultural operations. When a machine is unable to perform its intended tasks, it may result in decreased productivity, lost revenue, and increased operating costs. In some cases, downtime may also lead to missed deadlines for planting or harvesting crops, which may result in reduced yields and lower quality produce. Furthermore, prolonged downtime may result in additional wear and tear on the machine, which may further increase the likelihood of future breakdowns and reduce the lifespan of the equipment. Therefore, minimizing downtime is crucial for maintaining the efficient and profitable operation of agricultural businesses.

### BRIEF DESCRIPTION OF THE DRAWINGS

FIG. 1 illustrates a first example overview of the disclosed method in use.

FIG. 2 illustrates a second example overview of the disclosed method from a more functional perspective.

### DETAILED DESCRIPTION

As discussed in the background, providing services (interchangeably termed service operations) to repair agricultural working machines are known. However, the flexibility of such services for the customer and service providers may still be optimized.

US Patent Application Publication No. 2019/0347614 A1 discloses supply chain management that tracks parts and optimizes routes of parts. However, it is a challenge to improve on such tracking/optimization.

As such, in one or some embodiments, technical services of agricultural working machines may be reorganized such that service providers with service vehicles, for example service technicians with trucks loaded with professional tooling, and the needed parts to perform the services may be coordinated to arrive at a customer's location or unite prior to that arrival, with the technical service then being performed at the customer's location. In one or some embodiments, the necessary information has been gathered prior to performing the service and the necessary or even only potentially necessary parts have been ordered and delivered by part runners. The parts may arrive at the customer's location just-in-time or a meeting between the part runners and the service vehicles may be arranged.

The disclosed method thus allows executing a service in a single run at the location that the agricultural working machine currently is at or will be at the time of the service.

More specifically, a method is disclosed for providing technical service to an agricultural working machine, wherein a digital service module of a server for coordinating the technical service receives a request for service, with the request for service including at least one part and at least one service needed to fix at least one problem (or multiple problems) of the agricultural working machine. The server comprises a database, in which information about locations of parts and information about service providers and information about part runners is stored. The parts may include parts located in service vehicles of the service providers or which may be picked up by the service providers at locations assigned to the service providers. Alternatively, or in addition, the parts may include parts located at central storages that need to be sent to the service providers. The digital service module may derive one or more possible service events for one or more service providers, with the one or more possible service events including the service provider providing the services needed to fix the at least one problem of the agricultural working machine by using the parts needed. The digital service module may derive one or more possible routes for one or more part runners to pick up one or more parts located at the central storages and needed to fix the at least one problem of the agricultural working machine. The service vehicles may: (i) be vehicles manned with a service provider; (ii) comprise tools for servicing the agricultural working machine; and (iii) be used to service multiple agricultural working machines with the same tools. The digital service module may thus perform overall coordination, such as coordination of any one, any combination, or all of: at least one out of a number of available part runners; at least one out of a number of available service vehicles equipped to provide the service; and at least one out a number of parts usable for the service to provide the service at a customer's location. The digital service module may thereby cause the agricultural working machine to be fixed with the at least one part using the at least one service vehicle (e.g., via the various coordination with determining the part(s) for service, with facilitating transport (e.g., automated transport) of the part(s), with determining the service provider(s), with determining the service vehicle(s), etc.).

In one or some embodiments, the requests for service may contain information about any one, any combination, or all of: defective parts; replacement parts; and services needed. The digital service module may then use this information to plan the routes of the service providers and part runners.

In one or some embodiments, the information may comprise information about locations of instances of the parts. In one or some embodiments, a part may comprise the abstract representation of a certain part or type of part. An instance of a part may be the actual physical part. Many instances of a single part may be present in a single central storage or in multiple central storages. The instances may differ in the details, for example by being different versions of a respective part. In one or some embodiments, the information about parts may also include information about replacement parts for replacing defective parts.

In one or some embodiments, information may comprise where the part runners may deliver the parts. For example, the routes may include picking up the one or more parts and delivering the one or more parts to at least one of the service provider at a location between service events or the locations assigned to the service providers or a location of an already-planned service event prior to the possible service event or a location of the possible service event.

In one or some embodiments, existing plans for service vehicles and part runners may need to be considered when planning new routes. These planning of new routes may be at least partly flexible and some parts of the plans may be changeable by the digital service module. For example, information about time plans with already-planned service events and locations for the providers of services and availabilities may be stored in the database, with that information about time plans with already-planned routes and availabilities of part runners being stored in the database. Further, the information about the time plans with already-planned service events and locations may comprise time and/or location of planned service events with the locations of the planned service events at which the service provider provides services to other agricultural working machines and a route between the service events. The digital service module may derive at least one of the possible service events such that it fits into the time plan between the already-planned service events or after the already-planned service events, and/or, that the digital service module may derive at least one of the possible service events such that it fits into the time plan only after changing at least one of the already-planned service events and derives the change of the already-planned service event.

In one or some embodiments, the digital service module may choose a possible service event as an actual service event and a possible route as an actual route for executing the actual service after the planning. Not chosen possible service events and routes may be discarded or kept as a backup. In particular, the information about time plans with already-planned routes and availabilities of part runners may comprise time and/or location of planned pickups of parts and planned deliveries of parts and a route between said pickups and deliveries. The digital service module may derive at least one of the possible routes such that it fits into the time plan between the already-planned pickups and deliveries or after the already-planned pickups and deliveries, and/or, that the digital service module may derive at least one of the possible routes such that it fits into the time plan only after changing at least one of the already-planned pickups and/or deliveries and derives the change of the already-planned pickup and/or delivery.

In one or some embodiments, the part runner and the service provider meet each other at a location on the route of the service provider or at the customer's place when the part runner delivers the part. Thus, one of the possible service events may be chosen as an actual service event and executed by one of the service providers to fix the problem of the agricultural working machine and that one of the possible routes is chosen as an actual route and one of the part runners picks up the one or more parts and delivers the one or more parts and the one or more parts is or are used by the service provider to fix the problem of the agricultural working machine. The actual routes may be planned such that both arrive at the location more or less at the same time.

In one or some embodiments, the actual service event may be executed at the location (such as the present location) of the agricultural working machine, such as without the agricultural working machine being moved towards a service location itself. In this regard, the one or more part runners may deliver the one or more parts at a location (such as the present location of the agricultural working machine) at which the part runner may rendezvous with the service vehicle.

In one or some embodiments, a digital maintenance module may be used to identify the problem of the agricultural working machine. For example, in one or some embodiments, a customer may contact a customer service, for example via telephone, a chatbot or the like, and provide information related to the problem of the agricultural working machine. The digital maintenance module may, together with the customer service, identify possible technical fault(s) as causes for the problem of the agricultural working machine and parts and services needed to fix the faults. In this regard, a customer may contact the customer service, with the customer service generating problem information about a problem with the agricultural working machine. In turn, the digital maintenance module may analyze the problem information and may identify one or more possible technical faults of the agricultural working machine that may be the cause for the problem of the agricultural working machine. The digital maintenance module may thus identify parts and/or services needed to fix one or more of the possible technical faults, and may generate the request for service comprising the identified parts and services.

In one or some embodiments, the digital maintenance module may identify multiple possible service events and may ultimately generate a plan such that the actual service provider is provided with parts to fix multiple possible technical faults that could be the reason for the problem(s). The service provider may then identify the technical fault after arriving at the agricultural working machine and optimally may already have the necessary parts for the service. Spare parts may then be sent back.

In one or some embodiments, the digital maintenance module may access remote service data sent by the agricultural working machine to identify the one or more possible technical faults and/or the needed parts and services. Such remote service data may be sent by many modern agricultural working machines and therefore may be readily available.

In one or some embodiments, communication may be between the digital service module and the service providers and part runners, which may be independent entities. Thus, the digital service module may receive information about constraints from the service providers and the part runners, with the constraints including information about which already-planned service events and routes that may be replanned. The digital service module may send the possible service events and the possible routes to the respective service providers and part runners and may receive confirmation whether the possible service events and the possible routes may be executed. The digital service module may then choose one of the confirmed possible service events as the actual service event and one of the confirmed routes as the actual route.

In one or some embodiments, the part runners may comprise any one, any combination, or all of autonomous land based vehicles, drones, or manned land based vehicles.

In one or some embodiments, other technical services may be coordinated, such as in the same manner as the technical services. Parts may then not be necessary. For example, software services, such as software updates, and/or diagnostic services may be coordinated by the digital service module.

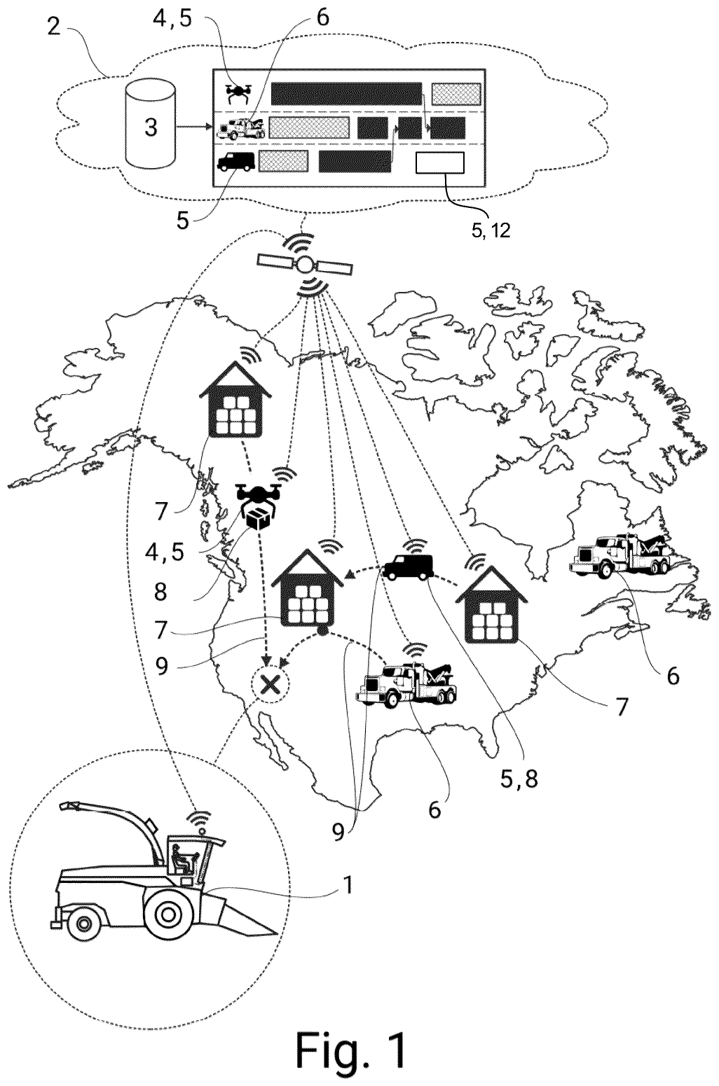

Referring to the figures, FIG. 1 illustrates one example of how an agricultural working machine 1 may be serviced according to the disclosed method. In FIG. 1, a technical service has been planned for the shown agricultural working machine 1 located at the position marked with an X (as shown in the map outline of the US and Canada). The technical service has been planned by a digital service module, which is explained further below and which may be hosted on a server 2 with a database 3.

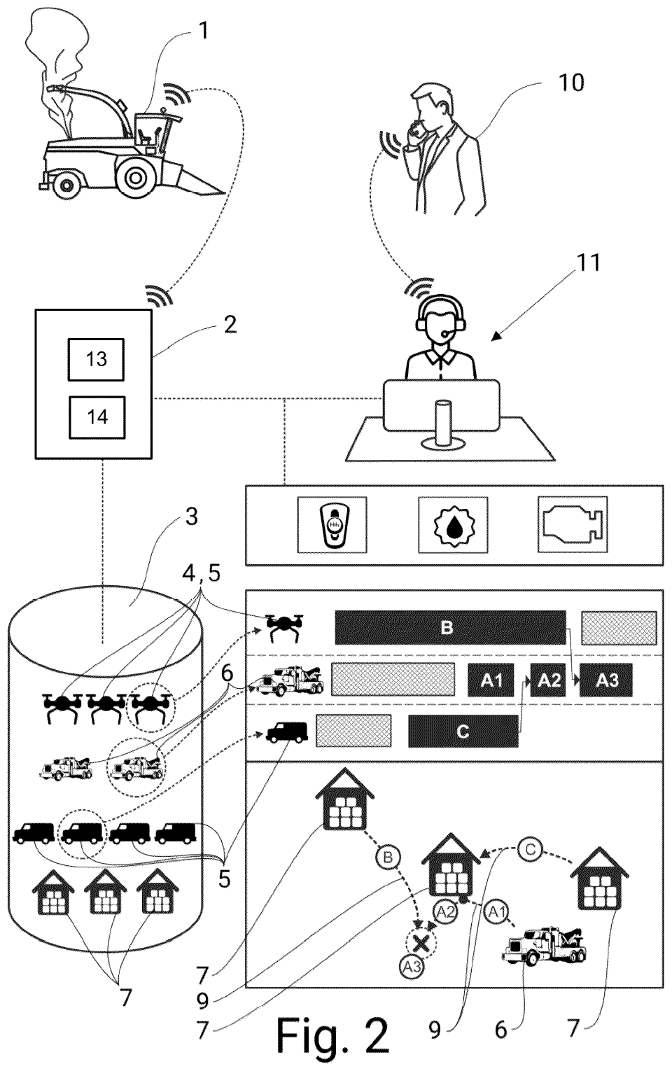

Server 2 (illustrated in FIG. 2) may comprise at least one processor 13 and at least one memory 14. Server 2 may include the at least one processor 13, with the processor configured to execute the software stored in the at least memory 14 (or in another memory device), which may comprise a non-transitory computer-readable medium that stores instructions that when executed by processor performs any one, any combination, or all of the functions described herein. Thus, the various routines described herein may comprise software routines, which may be executed by server 2, such as digital service module and/or digital maintenance module. In this regard, the server 2 may comprise any type of computing functionality, such as the at least one processor (which may comprise a microprocessor, controller, PLA, or the like) and a memory (such as memory 14 or database 3). The memory 14 may comprise any type of storage device (e.g., any type of memory). As shown in FIG. 2, processor 13 and memory 14 are depicted as part of a single machine. Alternatively, processor 13 and memory 14 may separate elements. Thus, processor 13 may comprise a microprocessor (or other type of controller) and a memory. Alternatively, processor 13 may rely on database 3 for all of its memory needs.

The server 2 is merely one example of a computational configuration. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

In one or some embodiments, the at least one part is autonomously transported to a site. Various ways are contemplated to at least partly autonomously transport the at least one part to a site. In one example, a drone 4 may be used. In another example, an autonomous vehicle 12 may be used. Further, various locations may be selected to autonomously transport the at least one part to. As one example, the at least one part may be autonomously transported to the current location of the agricultural working machine subject to fixing. As another example, the at least one part may be autonomously transported to a previous service event of the service vehicle. In this way, the service technician, performing the service event at the location of the previous service event, may pick up the at least one part (used to fix the agricultural working machine subject to fixing) there so that the service technician has the at least one part when the service technician travels to a subsequent service event at the location where the agricultural working machine subject is that is subject to fixing.

In one or some embodiments, the sequence of service events (e.g., service event #1 at location #1; service event #2 at location #2; service event #3 at location #3; etc.) may be predetermined and not dependent on autonomous transport. Still, the autonomous delivery of the at least one part may be made at one of the respective locations. In the example of three service events, service event #3 at location #3 may be the service event for the agricultural working machine with the at least one part at issue. In such an instance, in one or some embodiments, the at least one part may be autonomously transmitted to location #3 (wherein the agricultural working machine is). In this regard, the service technician will have the at least one part at location #3 so that the service technician can use the at least one part when fixing the agricultural working machine there. Alternatively, the at least one part may be autonomously transmitted to either location #1 or location #2 prior to the service technician being scheduled to be at location #1 or location #2, respectively. In such an instance, because the at least one part is autonomously transported to location #1 or location #2 prior to the service technician schedule to be at location #1 or location #2, the service technician, when at location #1 or location #2 prior to location #3, may be able to pick up the at least one part prior to travelling to location #3 for servicing the agricultural work machine 1.

Alternatively, the sequence of service events (e.g., service event #1 at location #1; service event #2 at location #2; service event #3 at location #3; etc.) may be at least partly dependent on autonomous transport. As one example, the sequence of service events may be selected based on location and/or timing (e.g., scheduling a service event later so that there is time to autonomously transport the at least one part for pick up; scheduling an autonomous delivery to a service event that is capable of receiving the autonomous delivery) so that the autonomous transport to transport the at least one part to a respective service event for the service technician to pick up the at least one part.

At the top of FIG. 1, a part of a plan for a drone 4 and an autonomous vehicle 12 as part runners 5 coordinated with a service vehicle 6 of a service provider is displayed. Actual plans may have more elements and may be more complex. Also, more than one service provider and more than two part runners 5 may be present. In this regard, FIG. 1 is an example illustration. The database 3 may comprise information about at least 50, such as at least 200, different parts.

In the main part of FIG. 1, three exemplary central storages 7 are shown at different locations. In the given example, two replacement parts 8 needed for the technical service are planned to be delivered by the shown drone 4 and the shown autonomous vehicle 12. The service provider in the service vehicle 6 picks up one of the parts delivered by the part runner 5 (which may have been delivered autonomously by the drone 4 or the autonomous vehicle 12) at one of the central storages 7, which may be close to the shortest route 9 between the service provider and the location of the agricultural working machine 1 (e.g., the current location of the agricultural working machine 1). Afterwards, the service provider may drive to the location of the agricultural working machine 1. Alternatively, the autonomous delivery (such as via drone 4 or autonomous vehicle 12) may deliver the part(s) directly to a service event. In either instance, there, the service provider may meet the drone 4, which may be (or may already have) delivering another replacement part 8, with the service provider performing a technical service on the agricultural working machine 1 using the part(s) and/or the replacement part(s) 8 autonomously delivered.

In one or some embodiments, instead of (or in addition to) a replacement part 8, any other part may be delivered. For example, the technical service may comprise updating the agricultural working machine 1 with new parts. The shown part runners 5 may be substituted by other part runners 5, such as trucks, hired drivers, etc.

FIG. 2 shows how the technical service of FIG. 1 may be planned more in detail. A customer 10 may contact (e.g., call) customer service 11 due to a problem with the agricultural working machine 1. The customer service 11, which may comprise an employee of the customer service 11, uses the server 2, such as a digital maintenance module (which may be part of the digital service module) executed on the server 2, to identify possible technical faults that led to the problem. In one or some embodiments, the server 2 may communicate with the agricultural working machine 1 sending remote service information about the problem to the digital maintenance module executed on the server 2. For example, the server 2 may send the agricultural working machine 1 one or more communications requesting any one, any combination, or all of status information, history information, sensor data, or the like. In response, the agricultural working machine 1 may send the requested information to the server 2. In this regard, the digital maintenance module may use the received information in order to identify the possible technical faults. As discussed herein, the digital maintenance module may determine that there are a plurality of possible technical faults and further may determine the part(s) needed for each of the respective plurality of possible technical faults. Thus, the autonomous delivery (via drone 4 and/or autonomous vehicle 12) may be more complicated since more than one part may be necessary to address each of the plurality of possible technical faults. For example, the digital service module may select drone(s) 4 and/or autonomous vehicle(s) 12 based on where the parts to address each of the plurality of possible technical faults are located. In one particular example, the digital service module may locate the parts to address each of the plurality of possible technical faults in any one, any combination, or all of service providers, service vehicles 6, part runners 5, or central storages 7. In this regard, the digital service module may select any one, any combination, or all of the service provider (from a plurality of available service providers), the service vehicle 6 (from a plurality of available service vehicles 6), a part runner 5 (from a plurality of available part runners 5), or a central storage 7 (from a plurality of available central storages 7) based on the location(s) of the parts to address each of the plurality of possible technical faults.

Thus, in one or some embodiments, the server 2 may also host the digital service module, which may be configured to plan a route 9 for a service provider with a service vehicle 6 and for a part runner 5 (e.g., by coordinating the drone 4 and/or autonomous vehicle 12 to automatically deliver one or more parts) to solve the problem of the agricultural working machine 1 by providing it with a service and a part needed for the service (in the depicted example, at least two parts needed). In one or some embodiments, the server 2 comprises a database 3 with information about any one, any combination, or all of service providers, part runners 5, central storages 7 and parts therein. In one or some embodiments, the digital maintenance module identifies one or more technical faults (e.g., three possible technical faults) that may have led to the problem. The digital maintenance module may then send the service provider to the agricultural working machine 1, equipped with and/or being delivered all parts necessary to solve the one or more possible technical faults (e.g., three possible technical faults). The service provider may therefore be prepared to solve the problem irrespective of which of the possible technical faults actually occurred without needing to order further parts. Parts not needed may be sent back later. In the example of three possible technical faults, parts to solve each of the technical faults may thus be autonomously sent to the service provider (e.g., the part may be autonomously sent to the central storage 7 for pick up by the service provider and/or the part may be autonomously sent to the current location of the agricultural working machine 1 so that the service provider and/or the part may be autonomously sent to the previous service location (earlier in the day) of the service provider of the agricultural working machine 1 so that, when arriving at the current location of the agricultural working machine 1, may access the part) or may be identified as currently accessible by the service provider (e.g., the central storage 7 already has the part, the service provider already has the part on a respective service vehicle so that the respective service vehicle is selected, from a plurality of available service vehicles, to be used to service the agricultural working machine 1, etc.). In this regard, the service provider may determine, at the current location of the agricultural working machine 1, which of the three possible technical faults is the actual problem. And, because the service provider already has the parts for each of the three possible technical faults, the service provider may be able to fix the agricultural working machine 1 without waiting for delivery of a part.

The central storages 7 may comprise main storages, each comprising at least 50%, such as at least 60%, at least 70% or at least 80% of all parts stored in the database 3. The central storages 7 may also comprise sub-storages comprising fewer parts. For at least some requests for service, at least one, such at least two, or at least three central storages 7, such as one or more main storages and/or one or more sub-storages, may have the required part(s). In one or some embodiments, the digital service module may coordinate (such as automatically coordinate) the part runners 5 (e.g., using drone(s) 4 and/or autonomous vehicle(s) 12) such that at least one of the parts is used for the service. In one example, the digital service module may coordinate the automated transport of the required part(s) from the central storage(s) 7 to a respective service location (either a service location that the service vehicle will be earlier in the day (prior to servicing the agricultural working machine) or a location of the agricultural working machine).

In an equal manner, several, for example at least 5 or at least 10, service vehicles 6 may be equipped to provide the service and several, for example at least 5 or at least 10, service vehicles 6 may not be equipped to provide the service and the digital service module may coordinate the service vehicles 6 such that the service is provided.

The coordinating may be performed via a digitally implemented algorithm in the digital service module.

Thus, in one or some embodiments, a method is disclosed for providing technical service to an agricultural working machine 1. The method may be a computer-implemented method executed by a server 2.

In one or some embodiments, a digital service module of a server 2 for coordinating the technical service receives a request for service. The request for service may include at least one part and at least one service needed to fix the problem of the agricultural working machine 1. The service may be performed by a service provider and the part may be delivered by a part runner 5.

The server 2 comprises a database 3. In the database 3, information about locations of parts and information about service providers and information about part runners 5 is stored. The locations of parts may include locations at central storages 7, inside service vehicles 6 and so on. For present purposes, at least one needed part is not available in a service vehicle 6. The information about service providers may comprise identification information, locations, plans, and routes 9, equipment, services performable and so on. The information about part runners 5 may comprise business information like prices, routes 9, plans and so on.

The parts, and therefore the information about the parts, include parts located in service vehicles 6 of the service providers or parts which may be picked up by the service providers at locations assigned to the service providers. The locations assigned to the service providers may be home locations, nearby central storages 7, meeting spots on the routes 9 or the location of the agricultural working machine 1. The parts may include parts located at central storages 7 that need to be sent to the service providers.

To ultimately perform the technical service, the digital service module may derive one or more possible service events for one or more service providers, the service events including the service provider providing the services needed to fix the problem of the agricultural working machine 1 by using the parts needed. The service events are aimed at fixing the problem of the agricultural working machine 1. At this stage, the plans are not yet final such that multiple possible service events for solving the same problem may be planned. A decision on which possible service event is actually executed may be made later.

The service vehicles 6 may be vehicles manned with a service provider. The service vehicles 6 may comprise tools for servicing the agricultural working machine 1. The service vehicles 6 may be used to service multiple agricultural working machines 1 with the same tools.

The digital service module may coordinate at least one part runner 5 from a plurality of available part runners 5, at least one service vehicle 6 from a plurality of available service vehicles 6 equipped to provide the service and at least one part from a plurality of parts usable for the service to provide the service at a customer's 10 location.

A technical service may comprise a repair, an upgrade, an inspection, or the like that uses mechanical parts and is executed by a service provider. In one or some embodiments, the technical service according to the disclosed method may only be conducted with a part which the service provider does not have on the service truck at the beginning of the planning. Other technical services may be planned in addition to the proposed service for other agricultural working machines 1.

The server 2 may be a virtual server 2 comprising hardware at different locations and is generally not bound to a specific piece of hardware.

The database 3 may be any kind of known database 3 and is also not bound to any specific hardware.

The digital modules described herein are software programs executed by the server 2.

A service provider may be a service technician with a service vehicle 6 or an entity with multiple service technicians and/or service trucks.

According to one embodiment, the request for service comprises a dataset including at least one presumably defective part of the agricultural working machine 1 causing the problem of the agricultural working machine 1. The presumably defective part may have been identified by the customer 10 or the customer service 11. For example, a specific valve may not open anymore and the agricultural working machine 1 may not be working. Then, the valve may be identified as the defective part.

As to the at least one part, the dataset of the request for service may include at least one replacement part 8 for replacing the defective part or a part of the defective part. This may be a replacement valve. Alternatively, the motor may have been identified as the defective part with different valves being the possible root causes for the problem. Then, the multiple valves may be the replacement parts 8 and sent to the customer's 10 location via the drones 4, for example.

As to the at least one service, the dataset of the request for service may include at least one service operation to be performed by the service provider on the defective part to fix the problem of the agricultural working machine 1. This service operation may be changing the defective valve for the replacement valve.

In one or some embodiments, the information about locations of parts stored in the database 3 includes information about multiple locations of instances of one part at different locations. For example, the valve may be present at each of the central storages 7 and any of those instances of the valve may be chosen to be sent to the service vehicle 6. The instances of the part are available to be used by the providers of services to fix the problem of the agricultural working machine 1.

Instances of a part may also include different versions of the part as long as the different versions are usable to solve the problem.

In a further embodiment, the information about locations of parts stored in the database 3 includes at least information about one or more locations of instances of the at least one replacement part 8.

According to one embodiment, the digital service module derives one or more possible routes 9 for one or more part runners 5 to pick up one or more parts located at the central storages 7 and needed to fix the problem of the agricultural working machine 1. The routes 9 may include picking up the one or more parts and the automated delivering of the one or more parts to at least one of the service provider at a location between service events or the locations assigned to the service providers or a location of an already-planned service event prior to the possible service event or a location of the possible service event.

Further, information about time plans with already-planned service events and locations for the providers of services and availabilities is stored in the database 3. These events may describe availabilities and non-availabilities of the service providers that need to be taken into account when planning the service event. Also, information about time plans with already-planned routes 9 and availabilities of part runners 5 is stored in the database 3.

The multiple services may be present in the information stored in the database 3. The service vehicles 6 may be service trucks with heavy equipment. The service vehicles 6 may have storage space for a number of bigger parts but are naturally not equipped with all the parts present in the central storages 7 such that the service vehicles 6 need to be paired with the respective parts sent around via the part runners 5 (e.g., via drones, autonomously vehicles, or the like).

In one or some embodiments, the information about the time plans with already-planned service events and locations comprises time and location of planned service events with the locations of the planned service events at which the service provider provides services to other agricultural working machines 1 and a route 9 between said service events. Exemplarily, a service provider may have a service event planned at a certain location for the morning and another service event for the next day. It may then be possible to place another service event in the evening near to the service event in the morning. The parts needed for the service event in the evening may be delivered directly to the customer 10 of the evening via a part runner 5 or to the location of the service event in the morning to be stored in the service vehicle 6. In this regard, one or more potential automated transport drop-off locations for the part may be available. After the digital service module automatically determines the drop-off location (selected from a plurality of potential drop-off locations, such as the current location of the agricultural working machine subject to repair, the location of service event being performed prior to the service event for the agricultural working machine subject to repair, or another location where the service vehicle may be present (such as location of the service provider that owns or operates the service vehicle)), the digital service module may automatically command or schedule the automated delivery (e.g., via drone 4 or autonomous vehicle 12).

The digital service module may derive at least one of the possible service events such that it fits into the time plan between the already-planned service events or after the already-planned service events. Additionally or alternatively, the digital service module derives at least one of the possible service events such that it fits into the time plan only after changing at least one of the already-planned service events and derives the change of the already-planned service event. Thus, the digital service module may be configured to determine a sequence of service events, and thereafter determine at which of the service events to automatically command or schedule the automated delivery (e.g., via drone 4 or autonomous vehicle 12).

It may be the case that a service provider has regular maintenance scheduled for a certain day and that a customer 10 calls with an urgent problem. The digital service module may reschedule the maintenance to fit in the urgent problem.

According to one embodiment, the information about time plans with already-planned routes 9 and availabilities of part runners 5 comprises time and location of planned pickups of parts and planned deliveries of parts and a route 9 between said pickups and deliveries.

The digital service module may then derive at least one of the possible routes 9 such that it fits into the time plan between the already-planned pickups and deliveries or after the already-planned pickups and deliveries. Additionally or alternatively, the digital service module derives at least one of the possible routes 9 such that it fits into the time plan only after changing at least one of the already-planned pickups and/or deliveries and derives the change of the already-planned pickup and/or delivery. Thus, separate from determining a sequence of service events, a determination as to where to deliver the part (e.g., at which of the service events to automatically command or schedule the automated delivery (e.g., via drone 4 or autonomous vehicle 12)), digital service module may determine the route(s).

In particular, the plans of part runners 5 may be changed regularly to adapt to new service events planned and to optimize the routes 9 of the part runners 5.

Further, in one or some embodiments, one of the possible service events may be chosen as an actual service event and executed by one of the service providers to fix the problem of the agricultural working machine 1 and that one of the possible routes 9 is chosen as an actual route 9 and one of the part runners 5 picks up the one or more parts and delivers the one or more parts and the one or more parts is or are used by the service provider to fix the problem of the agricultural working machine 1. The possible service events and routes 9 not chosen may be discarded.

According to one embodiment, the one or more part runners 5 deliver the one or more parts at a location at which the part runner 5 rendezvous with the service vehicle 6. The rendezvous location may be on the route 9 between customers 10, at a customer's 10 place or any other suitable location.

The rendezvous location may be optimized such that the service provider and/or the part runner 5 have a low waiting time at the rendezvous location. For example, in one or some embodiments, the actual service event is executed at the location of the agricultural working machine 1 at a customer's 10 place.

In the following, an exemplary process for deriving the request for service is described. As shown in FIG. 2, a customer 10 contacts a customer service 11. The customer service 11 generates problem information about a problem with the agricultural working machine 1. The problem information may, for example, be written down from an explanation of the problem by the customer 10 and supplemented with the experience of a service person.

The digital maintenance module may analyze the problem information and identify one or more possible technical faults of the agricultural working machine 1 that may be the cause for the problem of the agricultural working machine 1. The analysis may be performed automatically or in combination with the service person.

The digital maintenance module may identify parts and services needed to fix one or more of the possible technical faults. The digital maintenance module may generate the request for service comprising the identified parts and services.

The customer service 11 may be a digital customer service 11 or a human customer service 11. The customer service 11 may be contacted by the customer 10 via a phone, via the internet or in any other suitable manner. The contact may be with a machine like a chatbot or with a human.

The digital maintenance module may identify several possible technical faults of the agricultural working machine 1 that may be the cause for the problem of the agricultural working machine 1. The digital maintenance module may also identify a high number of possible technical faults, many of them having a very low possibility of being the actual technical fault.

The digital maintenance module may then identify parts and services needed to fix several of the possible technical faults. For example, the digital maintenance module may identify all parts and services needed to fix all problems with a predefined cumulated probability, for example of up to 90%.

The digital maintenance module may generate the request for service comprising the identified parts and services. For example, five possible technical faults may amount to the cumulated probability of up to 90%. Then, the parts needed to fix any or each of those five technical faults may be sent to the service provider (e.g., via drone 4 or autonomous vehicle 12). In another case, further identified technical faults may be solvable by small parts present at central storage 7 that one of the part runners 5 needs to visit anyway. For example, the digital maintenance module may determine where the parts for servicing each of the five possible technical faults are, and determine a best location for the service vehicle 6 to pick up the part based on where the parts are. Various options are available. As one option, the service vehicle 6 may pick up the part at the central storage 7 (to the extent the part is already at central storage 7 or to the extent delivery of the part by drone 4 or autonomous vehicle 12 to the central storage 7 is optimal, as determined by the digital maintenance module. As another option, the service vehicle 6 may pick up the part at a service event (such as a service event where the service vehicle 6 will be at prior to the service event where the service vehicle will be to service the agricultural working machine 1 subject to repair). Thus, the one or more part runners 5 may deliver the one or more parts at a location at which the part runner 5 may rendezvous with the service vehicle 6. Those parts may also be sent to the service provider.

The digital service module may derive one or more possible service events for one or more service providers, the service events including the service provider being able to provide the services needed to fix several of the possible technical faults by using different parts. In one or some embodiments, a service provider is automatically chosen by the digital service module that is able to solve all the possible technical faults amounting to the predefined probability. Otherwise, two service providers would have to be sent to the agricultural working machine 1 or a possible technical fault might not be fixable by the service provider.

The digital service module may derive one or more possible routes 9 for one or more part runners 5 to pick up several parts located at the central storages 7 and needed to fix the several of the possible technical faults.

According to one embodiment, the digital maintenance module receives remote service data from the agricultural working machine 1 and at least partially identifies the several possible technical faults by using said remote service data. Remote service data is often sent to the server 2 by the agricultural working machine 1.

According to another embodiment, the digital service module receives information about constraints from the service providers and the part runners 5 and that the constraints include information about which already-planned service events and routes 9 may be replanned.

The digital service module may send the possible service events and the possible routes 9 to the respective service providers and part runners 5 and receive confirmation whether the possible service events and the possible routes 9 may be executed. This case is particularly interesting if the service providers and/or the part runners 5 are independent of the customer service 11 and need to be contracted for the work.

The digital service module may then automatically choose one of the confirmed possible service events as the actual service event and one of the confirmed routes 9 as the actual route 9. The digital service module informs the respective service providers and part runners 5 about the chosen service events and routes 9. In addition, the digital service module may then command the automated delivery (such as by drone 4 or autonomous vehicle 12) based on the actual service event or the actual route 9. By way of example, once the actual service event is automatically selected and/or once the actual route 9 is automatically selected, the automated delivery may be selected and at least partly automatically implemented so that the part is delivered based on the actual service event and/or the actual route 9.

It may also be the case that the part runners 5 and/or service providers may provide information about the importance of currently planned routes 9 and service events such that the digital service module may be authorized to automatically change some of the plans in urgent cases.

According to one embodiment, the part runners 5 comprise at least one of autonomous land based vehicles, drones 4, manned land based vehicles.

Alternatively, or in addition, in one embodiment, software services, such as software updates, and/or diagnostic services may be automatically coordinated by the digital service module.

Thus, the digital service module may be configured to automatically determine any one, any combination, or all of: (i) possible service events at which the service provider can fix the problem of the agricultural working machine; (ii) possible routes for the part runners to deliver the at least one part from central storage; (iii) the part runner, from a plurality of available part runners, to deliver the part; (iv) the service vehicle, from a plurality of available service vehicles, to provide the service; and (v) the at least one part, from a plurality of parts usable for the service.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

1 agricultural working machine
2 server
3 database
4 drone
5 part runner
6 service vehicle
7 central storage
8 replacement part
9 route
10 customer
11 customer service
12 autonomous vehicle
13 processor
14 memory

1. A method for providing technical service to an agricultural working machine, the method comprising:
receiving, a digital service module of a server configured to coordinate the technical service, a request for service, the request for service including at least one part and at least one service needed to fix at least one problem of the agricultural working machine, wherein the server comprises a database, wherein the database stores information about locations of parts, information about service providers, and information about part runners, wherein the at least one part is selected from parts located in service vehicles of the service providers, which may be picked up by the service providers at locations assigned to the service providers, or located at one or more central storages that need to be sent to the service providers;
deriving, by the digital service module, one or more service events for one or more service providers, the one or more service events including the service provider providing services needed to fix the problem of the agricultural working machine by using the at least one part needed,
deriving, by the digital service module, one or more possible routes for one or more part runners to pick up the at least one part located at the central storages and needed to fix the problem of the agricultural working machine, wherein the service vehicles are vehicles manned with a respective service provider, wherein the service vehicles comprise tools for servicing the agricultural working machine, wherein the service vehicles are used to service multiple agricultural working machines with the tools; and
coordinating, by the digital service module, at least one part runner, from a plurality of potential part runners, at least one service vehicle, from a plurality of available service vehicles, equipped to provide the service, and the at least one part, from a plurality of parts, usable for the service at a customer's location.

2. The method of claim 1, wherein the request for service comprises a dataset including at least one presumably defective part of the agricultural working machine causing the at least one problem of the agricultural working machine as the at least one part for replacement or a part of a defective part, for at least one service operation to be performed by the service provider on the defective part to fix the problem of the agricultural working machine.

3. The method of claim 2, wherein the information about locations of parts stored in the database includes information about multiple locations of instances of the at least one part at different locations;
wherein the instances of the at least one part are available to be used by the service provider of services to fix the problem of the agricultural working machine; and
wherein the digital service module causes autonomous transport based on the instances of the at least one part.

4. The method of claim 3, wherein the information about the locations of parts stored in the database includes at least information about one or more locations of multiple instances of the at least one part.

5. The method of claim 1, wherein the one or more possible routes include picking up the at least one part and autonomously delivering the at least one part to at least one service provider at a location between service events or at least one location assigned to the at least one service provider or a location of an already-planned service event prior to a possible service event or a location of the possible service event for the agricultural working machine.

6. The method of claim 1, wherein information about time plans with already-planned service events and locations for the service providers and availabilities is stored in the database;
wherein the information about time plans with already-planned routes and availabilities of part runners is stored in the database; and
wherein the digital service module schedules autonomous transport using the information about time plans with already-planned service events and the information about time plans with already-planned routes.

7. The method of claim 6, wherein the information about the time plans with already-planned service events and locations comprises time and location of planned service events with the locations of the already-planned service events at which the service provider provides services to other agricultural working machines and a route between the service events; and
wherein the digital service module derives:
at least one possible service event such that it fits into the time plan between the already-planned service events or after the already-planned service events; or
at least one possible service event such that it fits into the time plan only after changing at least one of the already-planned service events and derives the change of the already-planned service event.

8. The method of claim 6, wherein the information about time plans with already-planned routes and availabilities of part runners comprises time and location of planned pickups of parts and planned deliveries of parts and a route between said pickups and deliveries; and
wherein the digital service module derives
at least one possible route such that it fits into the time plan between already-planned pickups and deliveries or after the already-planned pickups and deliveries; or
at least one of the possible routes such that it fits into the time plan only after changing at least one already-planned pickup or delivery and derives the change of the at least one already-planned pickup or delivery.

9. The method of claim 1, wherein at least one possible service event is chosen as an actual service event and executed by at least one service provider to fix the problem of the agricultural working machine and that at least one possible route is chosen as an actual route and at least one part runner picks up the at least one part and autonomously delivers the at least one part and the at least one part is used by the at least one service provider to fix the problem of the agricultural working machine.

10. The method of claim 1, wherein the at least one part runner delivers the at least one part to a location at which the at least one part runner rendezvous with at least one service vehicle.

11. The method of claim 10, wherein the actual service event is executed at the location of the agricultural working machine at a customer's place.

12. The method of claim 1, wherein a customer contacts a customer service;
wherein the customer service generates problem information about the at least one problem with the agricultural working machine;
wherein a digital maintenance module analyzes the problem information and identifies one or more possible technical faults of the agricultural working machine that may cause the at least one problem of the agricultural working machine;
wherein the digital maintenance module identifies parts and services needed to fix the one or more possible technical faults; and
wherein the digital maintenance module generates the request for service comprising the identified parts and services.

13. The method of claim 12, wherein the digital maintenance module identifies several possible technical faults of the agricultural working machine that may be cause the at least one problem of the agricultural working machine;
wherein the digital maintenance module identifies the parts and services needed to fix the several possible technical faults;
wherein the digital maintenance module generates the request for service comprising the identified parts and services;
wherein the digital service module derives one or more possible service events for one or more service providers, the one or more possible service events including the one or more service providers providing the services needed to fix the several possible technical faults by using different parts; and
wherein the digital service module derives one or more possible routes for one or more part runners to pick up the different parts located at at least one central storage and needed to fix the several possible technical faults.

14. The method of claim 13, wherein the digital maintenance module receives remote service data from the agricultural working machine and at least partially identifies the several possible technical faults by using the remote service data.

15. The method of claim 14, wherein the digital service module receives information about constraints from the one or more service providers and the one or more part runners;
wherein the constraints include information about which already-planned service events and routes may be replanned;
wherein the digital service module sends the possible service events and the possible routes to the respective service providers and part runners and receives confirmation whether the possible service events and the possible routes may be executed;
wherein the digital service module then chooses one of a confirmed possible service event as the actual service event and one of a confirmed route as an actual route.

16. The method of claim 1, wherein the part runners comprise at least one of autonomous land based vehicles or drones.

17. The method of claim 1, wherein one or both of software updates or diagnostic services are coordinated by the digital service module.

18. The method of claim 1, wherein the digital service module causes the agricultural working machine to be fixed with the at least one part using the at least one service vehicle; and
wherein the digital service module selection at least partly automatically causes autonomous transport using the at least one part runner.

19. The method of claim 18, wherein the digital service module schedules the one or more service events based on the autonomous transport of the at least one part.

20. The method of claim 19, wherein the digital service module schedules a previous service event prior to servicing the agricultural working machine to be fixed with the at least one part so that the autonomous transport of the at least one part is delivered to a location of the previous service event in order for a service technician in the at least one service vehicle to pick up the at least one part at the location of the previous service event prior to servicing the agricultural working machine.
